(19) United States
(12) Patent Application Publication
(10) Pub. No.: US 2011/0086597 A1
(43) Pub. Date: Apr. 14, 2011

(54) APPARATUS FOR BAND PASS FILTERING AND SIGNAL RADIATION IN MOBILE TERMINAL

(75) Inventors: Yang-Woon ROH, Suwon-si (KR); Jung-Kon SON, Suwon-si (KR); Seung-Seok OH, Suwon-si (KR); Han-Yeop LEE, Seoul (KR)

(73) Assignee: SAMSUNG ELECTRONICS CO. LTD., Suwon-si (KR)

(21) Appl. No.: 12/898,130

(22) Filed: Oct. 5, 2010

(30) Foreign Application Priority Data
Oct. 14, 2009 (KR) 10-2009-0097586

(51) Int. Cl. H04B 1/034; H04B 1/04

(52) U.S. Cl. 455/95; 455/129

(57) ABSTRACT

A transmitter for band-pass-filtering a transmission signal and radiating the signal is provided. The transmitter includes a communication unit and a filtena. The communication unit generates a transmission signal. The filtena includes a combined filter and antenna, wherein the filter band-pass-filters the transmission signal and the antenna radiates the signal.

### PRIORITY

This application claims the benefit under 35 U.S.C. §119(a) of a Korean patent application filed in the Korean Intellectual Property Office on Oct. 14, 2009 and assigned Serial No. 10-2009-0097586, the entire disclosure of which is hereby incorporated by reference.

### BACKGROUND OF THE INVENTION

1. Field of the Invention

The present invention relates to a mobile terminal. More particularly, the present invention relates to an apparatus for band pass filtering and signal radiation in a mobile terminal.

2. Description of the Related Art

Recently, a mobile communication service has been rapidly developed with convenience and necessity. To receive a mobile communication service, users access a wireless communication network using a mobile terminal. Each user uses a type of mobile terminal that allows a communication service suitable for the user's purpose and use.

The mobile terminal includes a band pass filter for transmitting/receiving a signal in a frequency band allowed to a relevant wireless communication system, and an antenna for radiating the signal. For example, a transmission signal passes through the band pass filter, and is radiated to a radio channel via an antenna. At this point, a matching circuit for impedance matching between the band pass filter and the antenna is required. When the impedance matching between the band pass filter and the antenna is not made, a reflective wave is generated from the transmission signal, which causes deterioration of radiation power, and consequently, communication quality deteriorates.

The matching circuit is an indispensable element for improving the mobile terminal's performance and communication quality. However, the matching circuit requires more physical space in the mobile terminal and increased in manufacturing costs.

Therefore, a need exists for an apparatus and method for preventing increased physical space and manufacturing costs of a matching circuit, while maintaining a function of the matching circuit in a mobile terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus for preventing increased physical space and manufacturing costs of a matching circuit in a mobile terminal.

Another aspect of the present invention is to provide an apparatus having a structure where a band pass filter and an antenna are combined in a mobile terminal.

In accordance with an aspect of the present invention, a transmitter of a mobile terminal is provided. The transmitter includes a communication unit for generating a transmission signal, a filtena including a combined filter and antenna, wherein the filter band-pass-filters the transmission signal and the antenna radiates the signal.

In accordance with another aspect of the present invention, an apparatus for band-pass-filtering a transmission signal and radiating the transmission signal is provided. The apparatus includes an embedded filter implemented on a Printed Circuit Board (PCB), a dielectric surrounding the embedded filter, an antenna pattern implemented on the dielectric, and a feeding line providing a signal path between the embedded filter and the antenna pattern.

In according with yet another aspect of the present invention, a method for band-pass-filtering a transmission signal and radiating the transmission signal is provided. The method includes generating a transmission signal, impedance matching between the communication unit and a filtena, and transferring the transmission signal inside of the filtena via a reception path between the filtena and a matching circuit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a block diagram illustrating a transmitter inside a mobile terminal according to an exemplary embodiment of the present invention; and

FIGS. 2A and 2B illustrate a filtena in a mobile terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an apparatus and method for preventing an increased amount of physical space of a matching circuit in a mobile terminal and for reducing manufacturing costs of the matching circuit in a mobile terminal. In an exemplary implementation, the mobile terminal denotes a cellular phone, a Personal Communication System (PCS), a Personal Digital Assistant (PDA), an International Mobile Telecommunication-2000 (IMT2000) terminal, a laptop computer, a netbook, and the like.

The exemplary embodiments of the present invention provide a transmitter that excludes impedance matching of a matching circuit in a mobile terminal. More particularly, a mobile terminal according to the exemplary embodiments of the present invention includes an element that combines a band pass filter and an antenna. The combination of the band pass filter and the antenna may be referred to as a “filtena”. Since the band pass filter and the antenna are combined in one element, a matching circuit for impedance matching between the band pass filter and the antenna may be omitted.

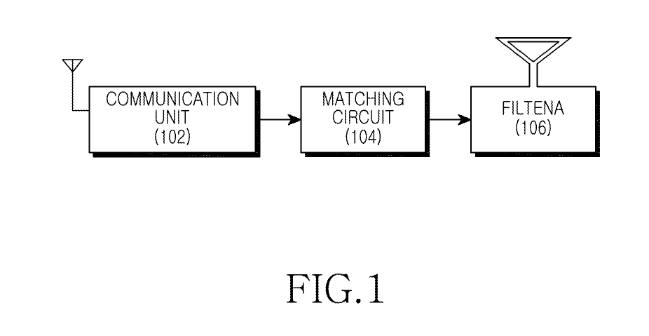

FIG. 1 is a block diagram illustrating a transmitter inside a mobile terminal according to an exemplary embodiment of the present invention.

Referring to FIG. 1, the transmitter includes a signal generator 102, a matching circuit 104, and a filtena 106.

The signal generator (i.e., a communication unit) 102 generates a transmission signal. At this point, the communication unit 102 generates the transmission signal according to a standard of a relevant communication system. For example, the communication unit 102 generates the transmission signal according to a standard such as a Bluetooth and a Wireless Local Area Network (WLAN). In a case of using a band of about 2.1 GHz or more as in the Bluetooth, an effect obtained by using the filtena 106 is maximized. For impedance matching between the communication unit 102 and the filtena 106, the matching circuit 104 provides inductance and capacitance to a path between the communication unit 102 and the filtena 106.

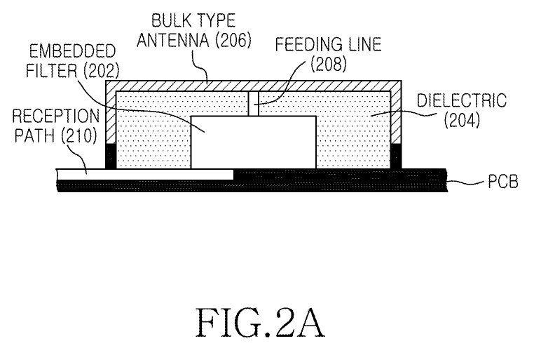

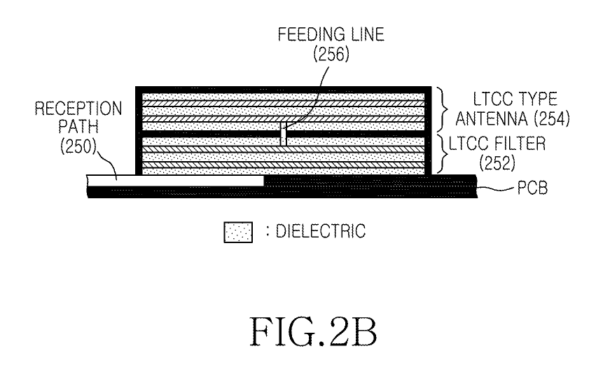

The filtena 106 performs band pass filtering on a transmission signal provided from the communication unit 102, and radiates a filtered signal to a radio channel. Since the filtena 106 performs both the function of the band pass filter and the function of the antenna, both a signal characteristic at an input end and a signal characteristic at an output end may meet a reference performance. In a structural point of view, the filtena 106 may be implemented on a Printed Circuit Board (PCB). At this point, the filtena may be divided into an antenna portion, a filter portion, and a feeding portion. The antenna portion may include a pattern for matching between the antenna portion and the filter portion. Hereinafter, a specific structure of the filtena 106 is described with reference to FIGS. 2A and 2B.

FIGS. 2A and 2B illustrate a structure of the filtena 106 in a mobile terminal according to an exemplary embodiment of the present invention.

Referring to FIG. 2A, the filtena 106 includes a embedded filter 202 implemented on a PCB, a dielectric 204 surrounding the embedded filter 202, a bulk type antenna 206 implemented on the dielectric 204, and a feeding line 208 that serves as a signal path between the embedded filter 202 and the bulk type antenna 206. For example, the feeding line 208 may be implemented in a shape of a passage whose inner portion is plated in a narrow empty space formed between the embedded filter 202 and the bulk type antenna 206. In addition, a reception path 210 between the filtena 106 and the matching circuit 104, for transferring a transmission signal to the embedded filter 202 inside the filtena 106, exists on the PCB.

Referring to FIG. 2B, the filtena 106 includes a Low Temperature Co-fired Ceramic (LTCC) filter 252 located on the PCB, an LTCC type antenna 254 located on the LTCC filter 252, and a feeding line providing a signal path between the LTCC filter 252 and the LTCC type antenna 254. The LTCC filter 252 and the LTCC type antenna 254 are implemented in a shape where a pattern is inserted inside a dielectric. The feeding line 256 may be implemented in a shape of a passage whose inner portion is plated in a narrow empty space formed between the LTCC filter 252 and the LTCC type antenna 254. In addition, a reception path 258 between the filtena 106 and the matching circuit 104, for transferring a transmission signal to the LTCC filter 252 in the lower portion of the filtena 106, exists on the PCB.

A mobile terminal uses an apparatus having a structure where a filter and an antenna are combined, so that space utility increases in an aspect of a mobile terminal design. In addition, the number of parts of the mobile terminal is reduced, so that manufacturing costs are reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A transmitter of a mobile terminal, the transmitter comprising:
a communication unit for generating a transmission signal; and
a filtena comprising a combined filter and antenna, wherein the filter band-pass-filters the transmission signal and the antenna radiates the transmission signal.

2. The transmitter of claim 1, wherein the transmission signal comprises a signal in a band of at least 2.1 GHz.

3. The transmitter of claim 1, wherein the filtena comprises:
an embedded filter implemented on a Printed Circuit Board (PCB);
a dielectric surrounding the embedded filter;
an antenna pattern implemented on the dielectric; and
a feeding line providing a signal path between the embedded filter and the antenna pattern.

4. The transmitter of claim 3, wherein the antenna pattern comprises a bulk type antenna pattern.

5. The transmitter of claim 3, wherein the antenna pattern comprises a pattern for matching between the antenna pattern and the embedded filter.

6. The transmitter of claim 1, wherein the filtena comprises:
a Low Temperature Co-fired Ceramic (LTCC) filter implemented on a Printed Circuit Board (PCB);
an LTCC type antenna stacked on the LTCC filter; and
a feeding line providing a signal path between the LTCC filter and the LTCC type antenna.

7. The transmitter of claim 1, further comprising:
a matching circuit for impedance matching between the communication unit and the filtena; and
a reception path between the filtena and the matching circuit, for transferring the transmission signal inside of the filtena.

8. An apparatus for band-pass-filtering a transmission signal and radiating the transmission signal, the apparatus comprising:
an embedded filter implemented on a Printed Circuit Board (PCB);
a dielectric surrounding the embedded filter;
an antenna pattern implemented on the dielectric; and
a feeding line providing a signal path between the embedded filter and the antenna pattern.

9. The apparatus of claim 8, wherein the transmission signal comprises a signal in a band of at least 2.1 GHz.

10. The apparatus of claim 8, wherein the antenna pattern comprises a bulk type antenna pattern.

11. The apparatus of claim 8, wherein the antenna pattern comprises a pattern for matching between the antenna pattern and the embedded filter.

12. The apparatus of claim 8, further comprising:
a Low Temperature Co-fired Ceramic (LTCC) filter implemented on a Printed Circuit Board (PCB);
an LTCC type antenna stacked on the LTCC filter; and
a feeding line providing a signal path between the LTCC filter and the LTCC type antenna.

13. A method for band-pass-filtering a transmission signal and radiating the transmission signal, the method comprising:
generating a transmission signal;
impedance matching between a communication unit and a filtena; and
transferring the transmission signal inside of the filtena via a reception path between the filtena and a matching circuit.

14. The method of claim 13, wherein the transmission signal comprises a signal in a band of at least 2.1 GHz.

15. The method of claim 13, wherein the filtena comprises a combined filter and antenna.

16. The method of claim 13, wherein the filtena comprises:
an embedded filter implemented on a Printed Circuit Board (PCB);
a dielectric surrounding the embedded filter;
an antenna pattern implemented on the dielectric; and
a feeding line providing a signal path between the embedded filter and the antenna pattern.

17. The method of claim 13, wherein the filtena comprises:
a Low Temperature Co-fired Ceramic (LTCC) filter implemented on a Printed Circuit Board (PCB);
an LTCC type antenna stacked on the LTCC filter; and
a feeding line providing a signal path between the LTCC filter and the LTCC type antenna.
